(19) United States
(12) Patent Application Publication
(10) Pub. No.: US 2010/0058555 A1
(43) Pub. Date: Mar. 11, 2010

(54) Adjustable handle extension

(76) Inventors: Essie Dube, Wickford, RI (US); William A. Dalpe, Rehoboth, MA (US)

Correspondence Address: Richard D. Zimmerman;Chace Ruttenberg & Freedman LLP, Suite 300, One Park Row, Providence, RI, 02903, US

(21) Appl. No.: 12/231,732

(22) Filed: Sep. 5, 2008

(51) Int. Cl. E05B 1/00

(52) U.S. Cl. 16/110.1

(57) ABSTRACT

The handle extension 30 comprises a base 40, a handle 60, a handle connector 80 and at least one base connector 100. The handle extension 30 attaches to a wheelbarrow or other device to improve the user's leverage, and permit easier use by shorter and taller users, and users with less strength and flexibility. The base 40 is removably and adjustably attached to a wheelbarrow or other device by at least one base connector 100. The handle 60 of the handle extension 30 is removably and adjustably attached to the base 40. The user may adjust the handle extension 30 throughout a wide range of positions by adjusting the placement of the base 40 on the device, and by adjusting the handle 60 relative to the base 40.

### FIELD OF INVENTION

This invention concerns devices to extend handles.

### BACKGROUND

Wheelbarrows, carts and other wheeled containers usually have handles to assist the user in lifting, pushing, moving or otherwise operating the container. Similarly, numerous other containers and devices include a handle constituting a lever to provide the user with mechanical leverage in operating the container or device.

Known wheelbarrow handles, and many other lever-handles, are fixed relative to the wheelbarrow, cart or other container or device, and do not permit adjustment based on the user's size, strength or physical condition, or on the size or weight of the load. For example, wheelbarrows do not permit adjustment of handles to allow for shorter or taller users or for users with less strength or flexibility. Wheelbarrows also do not permit adjustment of handles to allow for carrying loads longer than the wheelbarrow body, such as rakes, similar garden tools or shovels, without either extending the tool's handle over the edge of the wheelbarrow body or having the tool's handle contact the user as the wheelbarrow is moved.

What is needed is a relatively inexpensive handle extension that is easy to attach to and remove from known wheelbarrow or other handles, which handle extension is adjustable for different heights, strengths and flexibility of users, and for different loads.

### SUMMARY OF INVENTION

The improved handle extension 30 comprises a base 40, a handle 60, a handle connector 80 and at least one base connector 100. The handle 60 may include a grip pad 63. The base preferably is removably and adjustably attached to a wheelbarrow or other device. Neither the wheelbarrow nor other devices, or their respective handles, are part of the invention, but a device handle 120, such as a wheelbarrow handle, is depicted in FIGS. 2, 3 & 5, to show the handle extension 30 as it may be attached to known devices. The handle 60 of the handle extension 30 preferably is removably and adjustably attached to the base 40. The user may adjust the handle extension throughout a wide range of positions by adjusting the location of the base 40 on the device, and by adjusting the handle 60 relative to the base 40. The handle 60 preferably is held in an adjustably fixed position relative to the base 40 by at least one handle connector 80. The user may adjust the handle 60 relative to the base 40 by operating the handle connector 80.

### BRIEF DESCRIPTION OF THE DRAWINGS

These and other features, aspects and advantages of the present invention will become better understood with regard to the following description, appended claims and accompanying drawings, in which:

FIG. 1 is a side view of the handle extension;

FIG. 2 is a side view of the handle extension attached to a wheelbarrow handle;

FIG. 3 is a top view of the handle extension attached to a wheelbarrow handle;

FIG. 4 is a back view of the handle extension;

FIG. 5 is an exploded perspective view of the handle extension attached to a wheelbarrow handle;

FIG. 6 is a top view of a base;

FIG. 7 is a back view of the base;

FIG. 8 is a bottom view of the base;

FIG. 9 is a perspective view of the base;

FIG. 10 is a top view of a base;

FIG. 10A is a top view of the base of FIG. 10, marked to show the sectional view of FIG. 12A;

FIG. 11 is a left side view of the base;

FIG. 12 is a back view of the base;

FIG. 12A is a sectional view of the base along the 12-12′ line in FIG. 10A;

FIG. 13 is a right side view of the base;

FIG. 14 is a bottom view of the base;

FIG. 15 is a side view of the handle;

FIG. 16 is a back view of the handle;

FIG. 17 is a front view of the base connector compression pad;

FIG. 18 is a side view of the base connector compression pad;

FIG. 19 is a back view of the base connector compression pad;

FIG. 20 is a top view of the base connector compression wedge;

FIG. 21 is a side view of the base connector compression wedge;

FIG. 22 is a perspective view of the base connector compression wedge;

FIG. 23 is a perspective view of an alternative base;

FIG. 24 is a top view of an alternative base;

FIG. 25 is a back view of an alternative base; and

FIG. 26 is a right side view of an alternative base.

### DETAILED DESCRIPTION

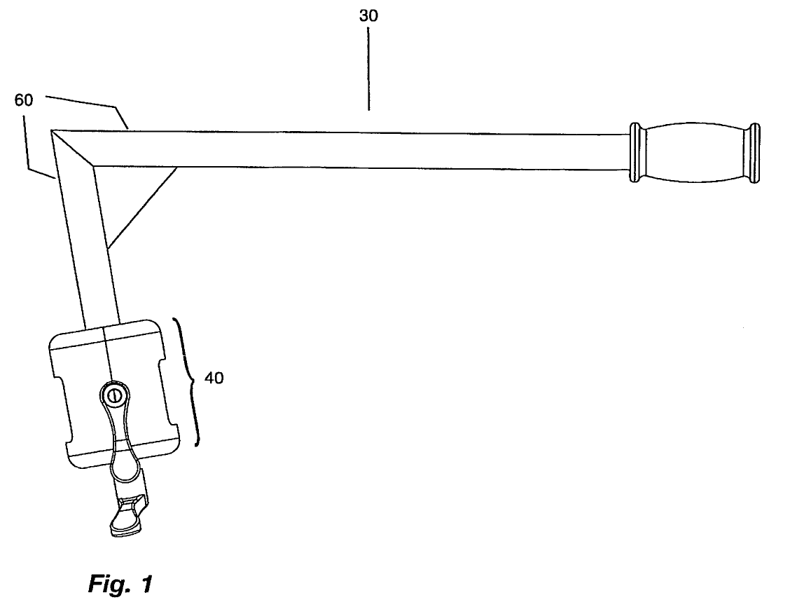

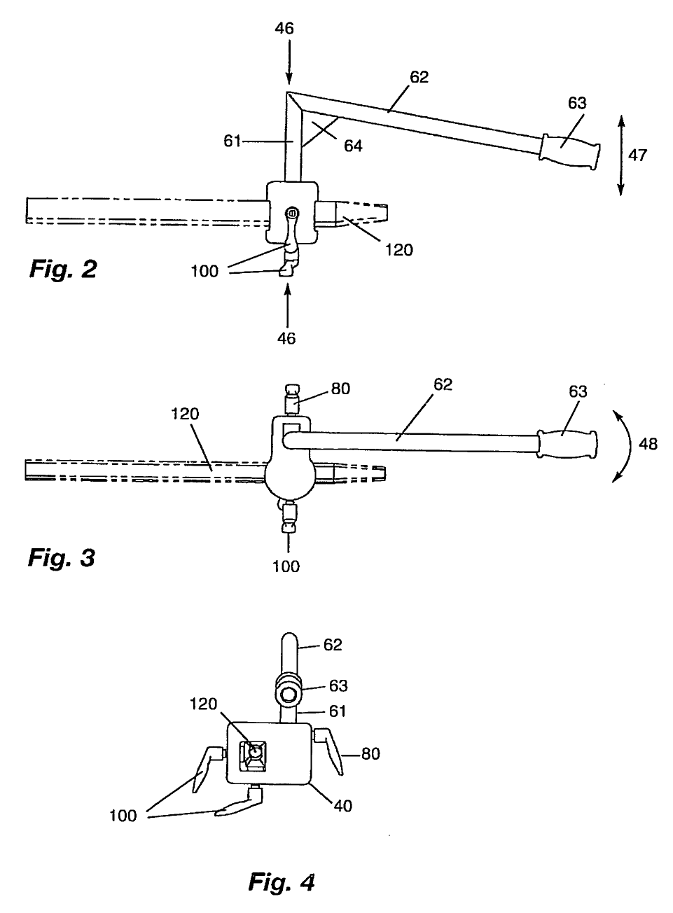

As shown in FIGS. 1, 3, 4 & 15, the handle extension 30 comprises a base 40, a handle 60, a handle connector 80 and at least one base connector 100. The handle 60 may include a grip pad 63. The base preferably is removably and adjustably attached to a wheelbarrow or other device handle 120, shown in FIGS. 2, 3 & 5. The device handle 120 is not part of the invention, but is depicted to show how the handle extension 30 may be used on a device. The handle 60 of the handle extension 30 preferably is removably and adjustably attached to the base 40, permitting the user to adjust the extension handle throughout a wide range.

As used in the specification and claims, “device” refers to wheelbarrows, carts or other containers, structures, products, machines or manufactures which are operated or used with a handle or lever. The containers may be wheeled, as are wheelbarrows, hand carts and wagons. Other devices frequently employ handles or handle-levers having a relatively straight portion, or may be annular, as with many valve handles. Some devices, such as trash containers, may be without wheels, and may have handles of limited size, fixed handles, or no handles.

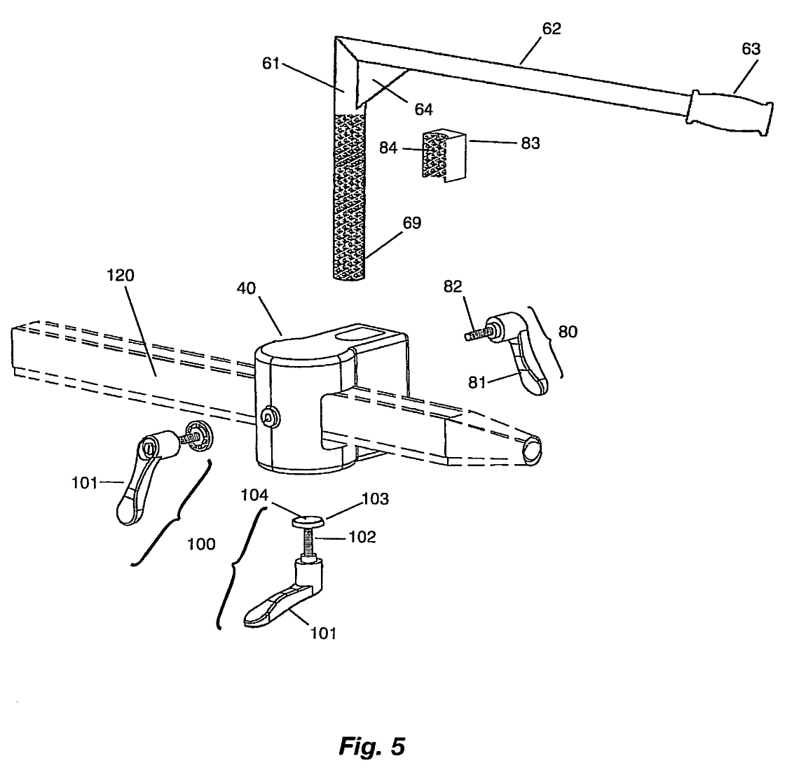

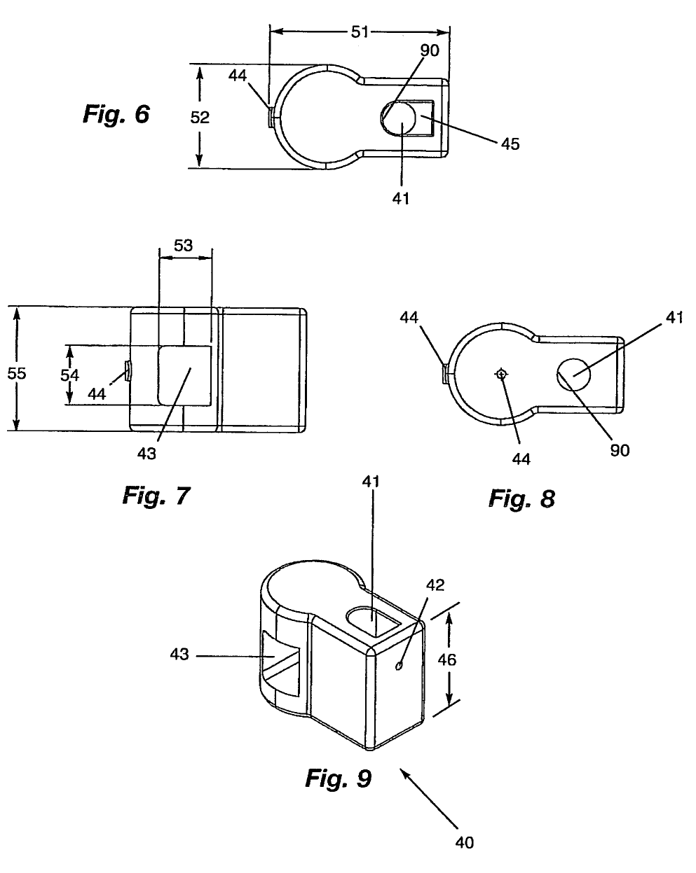

The base, shown in FIGS. 2, 5 & 6-14, is used to connect or mount the handle extension 30 to the wheelbarrow or other device. In the embodiment shown in FIGS. 6-14, the base 40 comprises a base handle aperture 41, a base handle aperture port 42, a base device aperture 43, a base device aperture port 44, and a base handle aperture ledge 45. The base 40 is placed on a device handle 120 or other device attachment point, and removably attached to the device by at least one base connector 100, shown in FIGS. 4 & 5.

As seen in FIGS. 5 & 17-19, the base connector 100 comprises a base lever 101, and a compression pad 103 connected by a base post 102. The base post 102 is movably placed in the base device aperture port 44, shown in FIGS. 8 & 11, so that the base lever 101 is outside the base 40 and the base compression pad 103 is inside the base device aperture 43. The base device aperture port 44 and base post 102 are threaded with matching threads so that as the base lever 101 is turned, the base compression pad 103 moves in the base device aperture 43. If a device handle 120 is placed in the base device aperture 43, the base lever 101 may be turned to rotate the threaded base post 102 within the complimentary threaded base device aperture port 44 to press the compression pad 103 against the device handle 120. By firmly turning the base lever 101, the base may be removably fixed to the device.

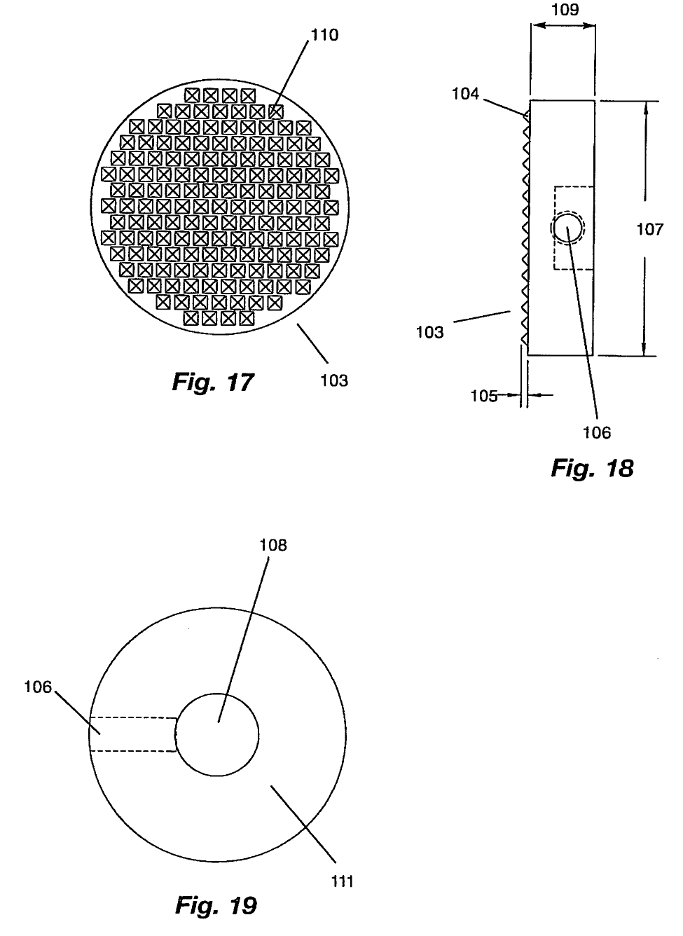

The compression pad 103, shown in FIG. 5 and in detail in FIGS. 17-19, preferably is larger than the base post 102 to compress the device handle 120 more effectively. In the preferred embodiment, the compression pad 103 is approximately circular, having a compression pad diameter 107 of approximately 1.25 inches. The compression pad 103 alternatively may include compression pad projections 104, shown in FIG. 18, to assist in compressing the device handle 120 more effectively. The compression pad 103 may be of a variety of materials, including metal, and if strong enough to withstand the stresses it experiences, plastics. The compression pad front surface 110 may be coated with abrasive materials to increase the coefficient of friction between the compression pad 103 and the device handle 120.

Alternatively, the compression pad 103 could be rectangular or other shapes, and could be a variety of sizes as needed to balance economy of construction and the need for adequate compression to resist forces during use.

As shown in FIG. 5, the device handle 120 may be rectangular. In the preferred embodiment for rectangular device handles, there are two base connectors 100, positioned with the longitudinal axes of their respective base posts at right angles so that the respective compression pads 103 can compress different sides of the rectangular device handle 120, as shown in FIGS. 4 & 5. For rounded or arced device handles, a single base connector 100 having a shape sized to fit the shape of the device handle 120 may be sufficient to hold the base 40 securely on the device. Compression pad projections 104 or abrasive coatings on the compression pad 103 may increase the strength of the connection between the base 40 and device handle 120. Substantial forces may be exerted on the base 40 due to the leverage created by the handle 60.

The base 40 alternatively may be relatively permanently attached to a device or device handle 120, such as with screws, nails, glue, brackets, welding or numerous other known methods of connecting materials, provided the method of attachment is sufficiently strong to withstand forces exerted when the handle extension 30 is in use. Permanently attaching the base, however, may limit adjustment of the base relative to the device, and restricts use of the handle extension on multiple devices, which flexible and multiple device uses are a benefit of the preferred embodiment using a base 40 removably fixed to a device.

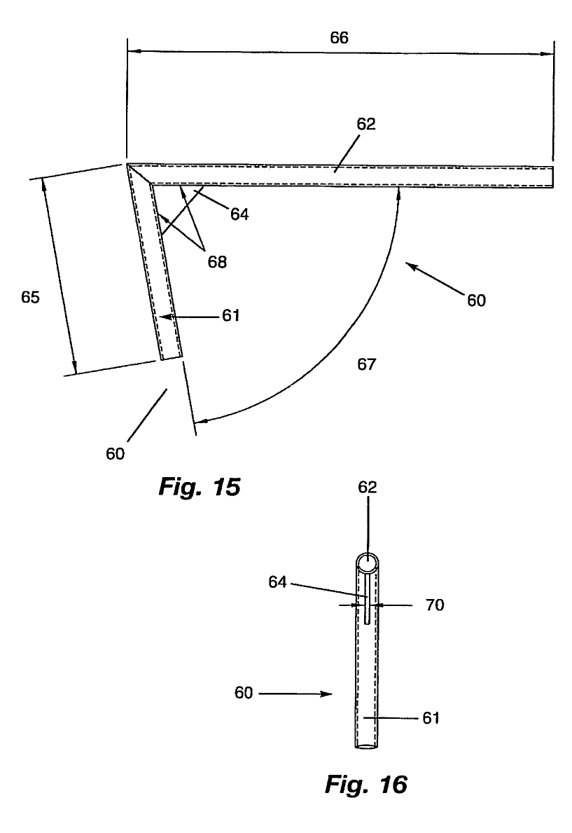

The handle 60 is movably connected to the base 40 with a handle connector 80. As shown in FIG. 15, the handle 60 comprises a handle-base segment 61 having a length 65 and a handle grip segment 62 having a length 66. In the preferred embodiment the handle 60 is made of two lengths of 6061 aluminum tubing at an interior segments angle 67 of approximately 80°, welded at the junction of the handle-base segment 61 and the handle-grip segment 62, where the handle-base segment length 65 is approximately 11.74 inches long, and the handle-grip segment length 66 is approximately 24.74 inches long. The preferred embodiment handle 60 includes a triangular handle reinforcement web 64 of aluminum plate, shown in FIG. 15, to strengthen the handle. The handle reinforcement web 64 is approximately 3 inches on each web side 68 connecting to the handle segments, and approximately one-eighth (⅛) to one-quarter (¼) inch thick, as shown by number 70 in FIG. 16. A variety of materials could be used for the handle, provided that the handle can withstand the forces exerted when the device is being used. The length of the handle could vary depending on the device on which the handle extension 30 will be used.

The handle 60 is adjustably mounted in the base handle aperture 41, as shown in FIGS. 2 & 3. As shown in FIGS. 2 & 9, the handle 60 is adjustable in the direction of the longitudinal axis 46 of the base handle aperture 41, shown alternatively as the vertical adjustment axis 47 in FIG. 2. The handle is adjustable substantially throughout the range provided by the handle base segment length 65, limited by the point where the handle reinforcement web 64 prevents insertion of the handle base segment 61 into the base, or where the handle base segment 61 is no longer held by the handle connector 80 in the base handle aperture 41.

The handle in the preferred embodiment also can be adjusted a full 360° about the longitudinal axis 46 of the handle-base segment 61, as indicated by the horizontal adjustment direction 48, shown in FIG. 3. This range of adjustment is facilitated by the round cross-sectional shape of the handle base segment 61 and the complimentary round base handle aperture 41.

Numerous alternative shapes could be used, including shapes having right angles in the cross-section of the handle base segment and base segment aperture. Complimentary angles on the base handle aperture 41 and handle base segment 61 generally restrict the range of adjustment of the handle relative to the base 40 and device, but allow the handle to experience greater forces without unwanted movement of the handle relative to the base 40 when the handle extension 30 is in use. Different users' needs dictate the optimal trade-off between the range of motion of the handle base segment 61 in the base 40 and the ability of the handle to resist forces when the handle extension 30 is in use. In the preferred embodiment, the handle base segment 61 includes knurling 69 to increase resistance of the handle to rotational forces when the handle extension 30 is in use.

As shown in FIGS. 3, 5 & 6, the handle 60 is removably and movably attached to the base 40 by a handle connector 80 that compresses the handle base segment 61 against the wall 90 of the base handle aperture 41. As shown in FIGS. 12 & 12A, the base handle aperture 41 has an elongated portion 49 and a round portion 50. The elongated portion 49 is larger than the round portion 50, in that the elongated portion 49 has a cross-section comprising a portion the same size as the cross-section of the round portion 50, as well as a handle aperture ledge 45 portion. The cross-section of the elongated portion 49 is shown in FIG. 6, and the cross-section of the round section 50 is shown in FIG. 8. The round portion 50 is sized to movably and removably hold the handle base segment 61, so that the handle base segment 61 can rotate in the base handle aperture 41. The elongated portion 49 is sized to hold the handle base segment 61 and the compression wedge 83.

As shown in FIG. 5, the handle connector 80 has a handle lever 81 and a handle post 82. Analogous to the compression connector structure used to connect the base to the device, described above, the threaded handle post 82 is placed in the threaded base handle aperture port 42, and as the handle lever 81 is turned, the handle post 82 compresses the compression wedge 83 to hold the handle base segment 61 firmly between the compression wedge 83, compression face 85 and wall 90 of the base handle aperture 41. When the handle connector 80 is loosened, the handle 60 can rotate freely about the longitudinal axis 46, of the handle base segment 61, also shown as 48 in FIG. 3, to the user's optimal setting. The handle 60 also may be adjusted to the desired height relative to the device handle 120, along the vertical adjustment axis 47 shown in FIG. 2, to the user's optimal setting. After adjustment, the handle connector 80 is tightened, and the handle 60 is held in a fixed position until the user again desires to adjust the handle. While the device is in use, such as when a wheelbarrow is being pushed, the base 40 is fixed relative to the device handle 120, and the handle 60 is fixed relative to the base 40.

As shown in FIG. 5, the compression face 85 and wall 90 preferably are shaped complimentarily to the handle base segment 61 to better hold the handle base segment. The handle base segment 61 and compression face 85 may have knurling 69 and wedge knurling 84, respectively, as shown in FIGS. 5 & 22, to further improve the holding characteristics, as described above.

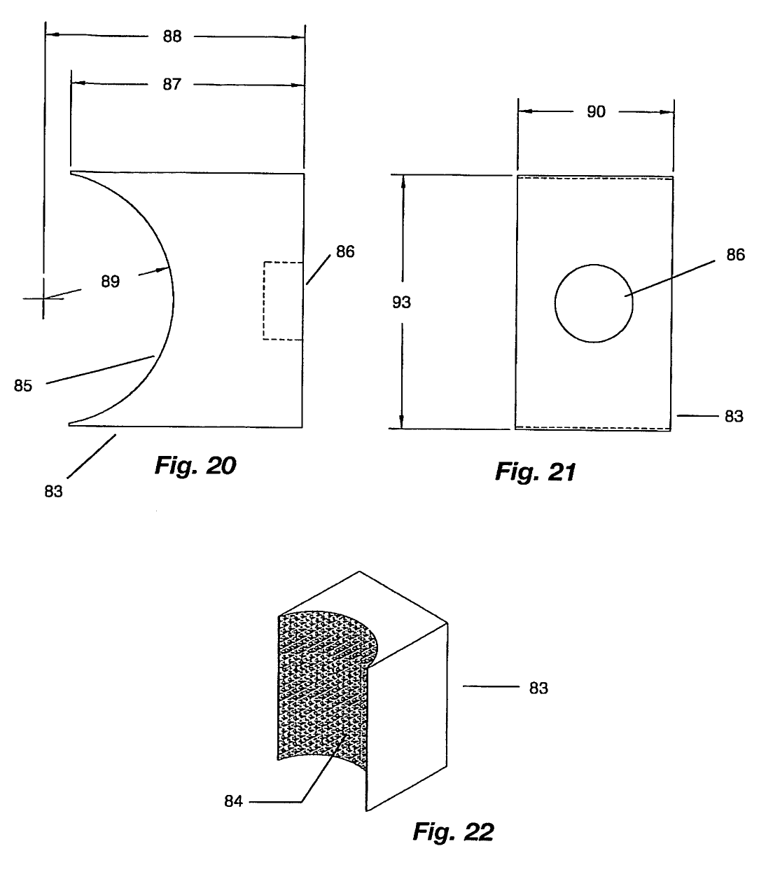

As shown in FIGS. 20-22, the compression wedge 83 has a handle post slot 86 to receive the handle post 82. The compression face 85 in the preferred embodiment, shown in FIG. 20, is approximately semi-circular, with a radius of approximately five-eighths (⅝) of an inch. A variety of shapes and sizes of the compression wedge may be more appropriate, depending on the user's needs.

The drawings show a single handle extension, but wheelbarrows, carts and other devices having two handles, or which are ordinarily operated with two hands, preferably use two handle extensions, one for each device handle, or one for each user's hand.

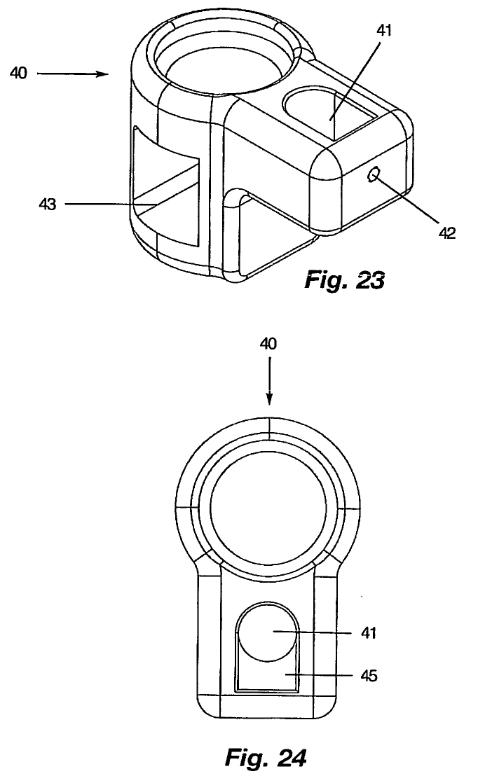

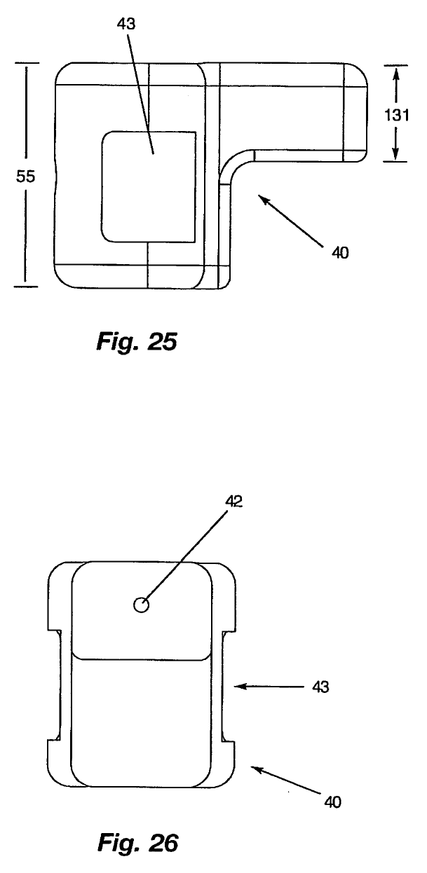

The preferred embodiment of the base 40 is depicted in FIGS. 23-26, which show a configuration having less mass than the alternative shown in FIGS. 5-14. Increased mass generally means that the handle extension will be more expensive to manufacture and use. As shown in FIG. 23, the preferred embodiment of the base 40 has a reduced base height 55 at the base handle aperture end. This difference can be seen by comparing the embodiment depicted in FIG. 7, in which the base height 55 is substantially uniform through out the base length 51, to the preferred embodiment shown in FIG. 25, in which the base height 55 at the base device aperture 43 end is greater than the base height at the base handle aperture end 131. Additional material is removed from the base top, at the handle aperture end 132, shown in FIG. 23.

As discussed before, a wide variety of materials, including aluminum, aluminum composites such as aluminum with fly ash, steel, stainless steel, and other alloys can be used to make the base 40. The materials and method of forming the base 40 can vary depending on the strength of the base needed for a particular application, and cost.

Additionally, the handle connector 80 and base connector 100 shown are the preferred embodiments primarily due to cost considerations. A wide variety of known clamping and holding structures could be adapted to the base 40 to hold the device handle 120 and the handle 60.

As discussed, a variety of sizes of components of the handle extension are appropriate, depending largely on the materials used, the size and nature of the device to which the handle extension is attached, and the optimal range of motion for the particular application. Applicant supplies the following dimensions to facilitate a better understanding of the invention, and not to suggest that the handle extension described by these dimensions is the only size that will function.

As shown in FIG. 6, the alternative base 40 is approximately 6.8 inches in base length 51, and approximately 4.0 inches in base width at the device aperture end 52. For the base shown in FIG. 7, the device aperture 43 is approximately 2.0 inches in aperture width 53, and approximately 2.38 inches in aperture height 54. The base 40 is approximately 4.88 inches in base height 55.

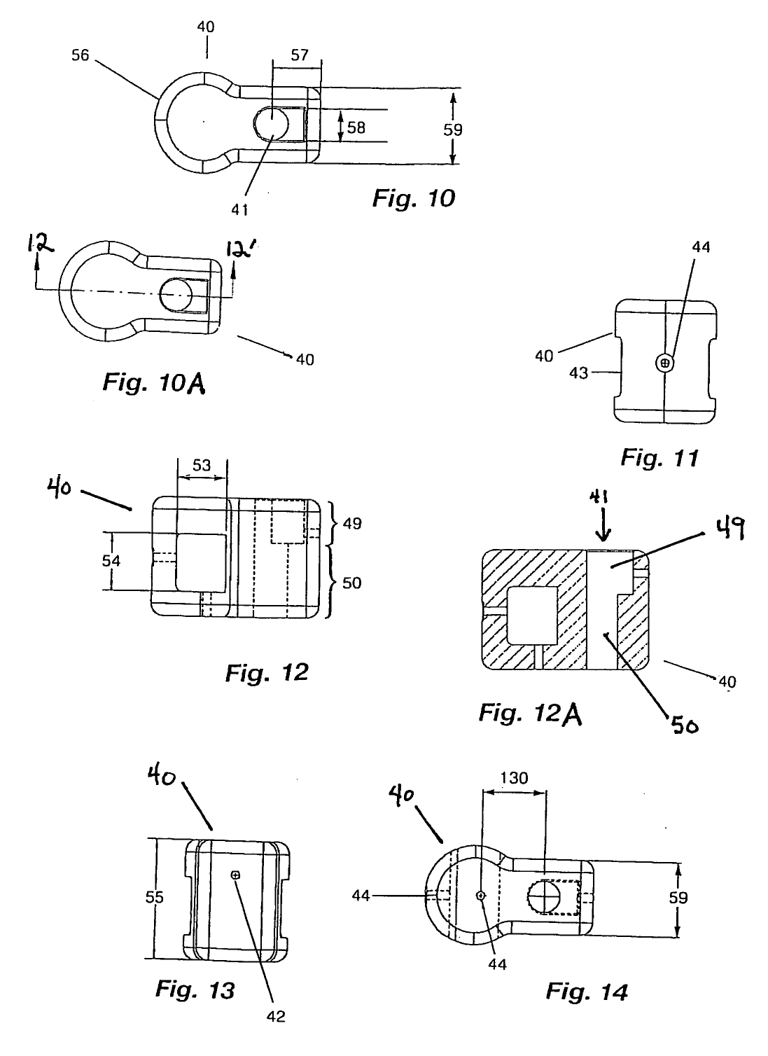

The base 40 shown in FIG. 10, has a device aperture end arc 56 of approximately 4 inches in diameter; a base handle aperture diameter 58 of approximately 1.255 inches; a base width at base handle aperture 59 of approximately 3.00 inches; and the distance to center of base handle aperture 57 of approximately 1.88 inches.

The base alternative shown in FIG. 14 has a distance between the center of the handle aperture and base device aperture port 130 of approximately 2.5 inches.

Although the present invention has been described in considerable detail with reference to certain preferred versions thereof, other versions are possible. Therefore, the spirit and scope of the appended claims should not be limited to the description of the preferred versions contained herein.

We claim:

1. An adjustable handle extension comprising a base connected to a handle, where the base has a structure that permits the base to be connected to a device.
